(19) United States
(12) Patent Application Publication
(10) Pub. No.: US 2002/0151235 A1
(43) Pub. Date: Oct. 17, 2002

(54) Dyed and/or printed nonwoven fabric

(76) Inventors: Heike Bartl, Weinheim (DE); Gabriele Emmerich, Neckarsteinach-Darsberg (DE)

Correspondence Address: KENYON & KENYON, ONE BROADWAY, NEW YORK, NY, 10004, US

(21) Appl. No.: 09/996,863

(22) Filed: Nov. 27, 2001

(30) Foreign Application Priority Data
Nov. 27, 2000 (DE) 100 58 791.7
Dec. 7, 2000 (DE) 100 61 124.9
May 25, 2001 (DE) 101 25 843.7

(51) Int. Cl. B32B 5/02; B32B 5/08; B32B 27/02; D04H 1/00

(52) U.S. Cl. 442/60; 442/168; 442/164; 442/351

(57) ABSTRACT

The present invention relates to a dyed and/or printed nonwoven fabric made of unsplit and/or at least partially split microfibres and/or microfilaments made of synthetic polymers containing at least one polyester component and at least one polyamide component and, possibly, at least one polyurethane component, as well as a method for its manufacture.

The present invention relates to a dyed and/or printed nonwoven fabric made of unsplit and/or at least partially split microfibres and/or microfilaments made of synthetic polymers containing at least one polyester component and at least one polyamide component and, possibly, at least one polyurethane component, as well as a method for its manufacture.

Textile materials made of polymers can generally only be dyed or printed inadequately by conventional textile dyeing or textile printing processes. Problems with dyeing or printing particularly occur when the textile material comprises different polymer components, such as polyester and polyamide. If, for example, the polyester component of a textile material of this kind is dyed with a disperse dyestuff, it often happens that the polyamide component of the material is stained by the dyestuff and/or the dyestuff migrates from the polyester component to the polyamide component when exposed to heat. This results in inadequate dye fastness and insufficient levelness of the dyed textile material. Other polymer components, such as polyurethane, are also often only stained by disperse dyestuffs.

The dyeing or printing of nonwoven fabrics consisting of a mixture of microfibres, such as polyester/polyamide split fibres, is a particular problem, as the split fibres are distributed irregularly in the nonwoven fabric. In corresponding polyamide/polyester microfibre fabrics, on the other hand, it is customary for only one component, generally the weft, to consist of polyamide/polyester split fibres.

Moreover, the fibre density, i.e. the number of fibres per unit area, is higher in nonwoven fabrics than in corresponding woven or knitted fabrics, meaning that, for example, greater quantities of dye are necessary for dyeing nonwoven fabrics of this kind. The increased dyestuff input, on the one hand, and the uneven distribution of the fibres, on the other hand, lead to the situation that dyed or printed nonwoven fabrics made of several polymer components usually display poorer dye fastness than corresponding woven fabrics made of the same synthetic polymers.

The object of the present invention was therefore to select suitable disperse dyestuffs for avoiding the above-mentioned disadvantages and thus to provide a dyed and/or printed nonwoven fabric, made of unsplit and/or at least partially split microfibres and/or microfilaments made of synthetic polymers containing at least one polyester component and at least one polyamide component and, possibly, at least one polyurethane component, which is characterised by good colour levelness, sufficient dye fastness, particularly wash, perspiration, water and rub fastness, as well as sufficient fastness to dry cleaning, and by good depth of colour.

This object was achieved by providing a dyed and/or printed nonwoven fabric, made of unsplit and/or at least partially split microfibres and/or microfilaments made of synthetic polymers containing at least one polyester component and at least one polyamide component and, possibly, at least one polyurethane component, which has been dyed and/or printed with at least one disperse dyestuff selected from the group of compounds according to the general formulae I to XIII, below, Palanil® Cyanin B and Dispersol® Tiefrot SF.

According to the invention, the nonwoven fabric is dyed and/or printed with at least one disperse dyestuff selected from the group of

1, compounds according to general formula I

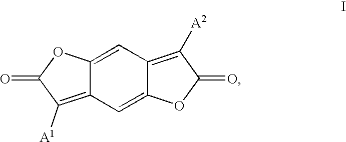

wherein

A¹ and A², which are identical or different, stand for H, a C₁₋₈-alkyl residue or a possibly substituted phenyl residue, preferably for a phenyl residue possibly substituted in ortho, meta or para position with a C₁₋₈-alkoxy residue or —O—CH₂—C₃₋₇ cycloalkyl residue, wherein the alkyl chain of the alkoxy residue or the cycloalkyl ring possibly displays at least one ether group as a chain or ring member, or for a residue with the formula —C₆H₄—OCH₂—COOC₂H₄OC₂H₅,

2, compounds according to general formula II

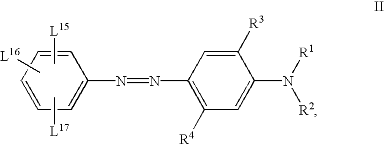

wherein

L¹⁵, L¹⁶ and L¹⁷, which are identical or different, stand for H, halogen, a C₁₋₆-alkyl or C₁₋₆-alkoxy residue, a nitro or cyano group, a C₁₋₆-alkylsulphonyl residue or for a possibly substituted C₁₋₄-alkoxycarbonyl, phenylsulphonyl or phenylazo residue, preferably for H, Cl, Br, or for a nitro or cyano group,

R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue, preferably for a methoxycarbonylethyl, 2-acetyloxyethyl, 2-cyanoethyl, ethyl or propyl residue, or for a residue with the formula —C₂H₄—O—CO—OCH₃ or —C₂H₄—O—CO—CH₂—O-phenyl,

R³ stands for H, a C₁₋₆-alkyl or C₁₋₆-alkoxy residue, preferably for H, a methoxy residue or an ethoxy residue,

R⁴ stands for H, a C₁₋₆-alkyl residue, a C₁₋₆-alkoxy residue, a C₁₋₆-alkylsulphonylamino residue or for a possibly substituted C₁₋₆-alkanoylamino or benzoylamino residue, preferably for H, an acetylamino, ethanoylamino, benzoylamino or methylsulphonylamino residue,

3, compounds according to general formula Ill

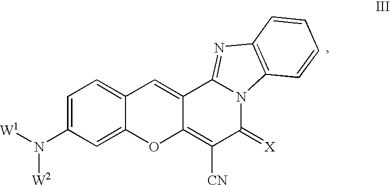

wherein

W¹ and W², which are identical or different, stand for a C₁₋₄-alkyl residue, preferably each for an ethyl residue,

X stands for an oxygen atom, a sulphur atom or an imino group, preferably for an oxygen atom or an imino group,

4, compounds according to general formula IV

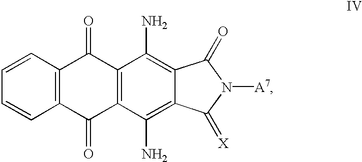

wherein

A⁷ stands for H or a C₁₋₈-alkyl residue with possibly at least one ether group as a chain member in the alkyl chain, preferably for a 3-methoxypropyl or 4,7-dioxaoctyl residue,

X stands for an oxygen atom, a sulphur atom or an imino group, preferably for an oxygen atom,

5, compounds according to general formula V

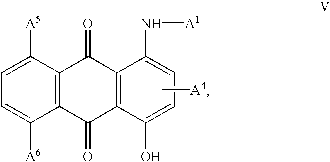

wherein

A¹ stands for H, a C₁₋₈-alkyl residue or for a possibly substituted phenyl residue, preferably for H,

A⁴ stands for halogen, a hydroxyphenyl residue, a phenoxy, C₁₋₄-alkoxyphenyl or 1-oxyhexane-6-ol-(—O—C₆H₁₂—OH) residue or for the group para-G¹-phenylene-G², wherein G¹ stands for an oxygen or sulphur atom and G² for a C₁₋₈-monoalkylsulphamoyl residue, whose alkyl chain possibly displays at least one ether group as a chain member, preferably for fluorine, chlorine, bromine, a 1-oxyhexane-6-ol, 2-methoxyphenyl, 3-methoxyphenyl, 4-methoxyphenyl, 2-ethoxyphenyl, 3-ethoxyphenyl, 4-cthoxyphenyl or phenoxy residue, one of residues A⁵ and A⁶ stands for a hydroxyl residue and the other residue, A⁵ or A⁶, means the group NH-A¹′, wherein A¹′ stands for H, a C₁₋₈-alkyl residue or a possibly substituted phenyl residue,

or residues A⁵ and A⁶ each stand for H,

6, compounds according to general formula VI

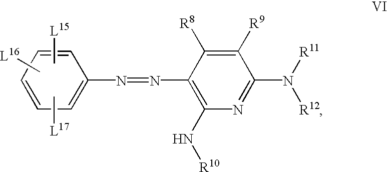

wherein

L¹⁵, L¹⁶ and L¹⁷, which are identical or different, stand for H, halogen, a C₁₋₆-alkyl or C₁₋₆-alkylsulphonyl residue, a nitro or cyano group, or for a possibly substituted C₁₋₄-alkoxycarbonyl, phenylsulphonyl or phenylazo residue, preferably for H or for a nitro or cyano group,

R⁸ stands for H or a C₁₋₆-alkyl residue, preferably for a methyl residue,

R⁹ stands for a carbamoyl or acetyl residue or for a cyano group, preferably for a cyano group,

R¹⁰, R¹¹ and R¹², which are identical or different, stand for H, a possibly at least monosubstituted C₁₋₁₂-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted phenyl or benzyl residue, C₃₋₆-alkenyl residue, possibly substituted benzoyl, C₁₋₈-alkanoyl, C₁₋₆-alkylsulphonyl or phenylsulphonyl residue, preferably for H, an unsubstituted phenyl, cyanoethyl or methoxycarbonylethyl residue, or for a 3-oxa-5-hydroxypentyl residue with the formula (C₂H₄—O—C₂H₄—OH),

or residues R¹¹ and R¹², together with the nitrogen atom connecting them, stand for a 5 or 6-member, saturated ring system with possibly at least one further heteroatom, preferably for a pyrrolidinyl, piperidinyl, morpholinyl, thiomorpholinyl, thiomorpholinyl-S,S-dioxide, piperazinyl or N-(C₁₋₄-alkyl)piperazinyl residue, preferably for an N-methyl or N-ethylpiperazinyl residue,

7, compounds according to general formula VII

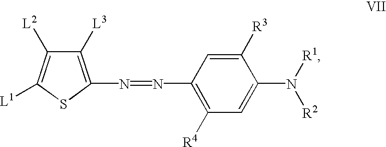

wherein

L¹ stands for a nitro or cyano group, for a C₁₋₆-alkanoyl, benzoyl, C₁₋₆-alkylsulphonyl residue or for a possibly substituted phenylsulphonyl residue, preferably for a nitro group,

L² stands for H, a C₁₋₆-alkyl, halogen, hydroxy or mercapto residue, a C₁₋₆-alkoxy residue possibly at least monosubstituted with a phenyl or C₁₋₄-alkoxy residue, a possibly substituted phenoxy residue, a C₁₋₆-alkylthio residue possibly at least monosubstituted with a phenyl residue, a possibly substituted phenylthio residue, a C₁₋₆-alkylsulphonyl residue or for a possibly substituted phenylsulphonyl residue, preferably for H,

L³ stands for H, a cyano or nitro group, or for a C₁₋₄-alkoxycarbonyl residue, preferably for H, a nitro group, or for a C₁₋₄-alkoxycarbonyl residue,

R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyl-oxy-C₁₋₄-alkyl residue, a C₅₋₇-cycloalkyl residue, a possibly substituted benzyl residue or C₃₋₆-alkenyl residue, preferably for a methoxycarbonylethyl, 2-acetyloxyethyl or 2-cyanoethyl residue,

R³ stands for H, a C₁₋₆-alkyl or C₁₋₆-alkoxy residue, preferably for H,

R⁴ stands for H, a C₁₋₆-alkyl residue, a C₁₋₆-alkoxy residue, a C₁₋₆-alkylsulphonylamino residue, a possibly substituted C₁₋₆-alkanoylamino or benzoylamino residue, preferably for H or a C₁₋₃-alkyl residue,

8, compounds according to general formula VIII

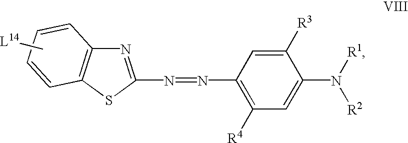

wherein

L¹⁴ stands for H, halogen, a cyano, —SCN or nitro group, or for a C₁₋₄-alkoxycarbonyl residue, preferably for an —SCN or nitro group,

R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue, preferably for an acetyloxyethyl, cyanoethyl or methoxycarbonylethyl residue,

R³ stands for H, a C₁₋₆-alkyl or C₁₋₆-alkoxy residue, preferably for H,

R⁴ stands for H, a C₁₋₆-alkyl residue, a C₁₋₆-alkoxy residue, a C₁₋₆-alkylsulphonylamino residue, a possibly substituted C₁₋₆-alkanoylamino or benzoylamino residue, preferably for H or a C₁₋₃-alkyl residue,

9, compounds according to general formula IX

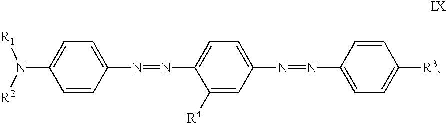

wherein

R¹ and R²,which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue, preferably for H, an acetyloxyethyl or a methoxycarbonyl residue,

R³ stands for H, a hydroxy, C₁₋₆-alkyl or C₁₋₆-alkoxy residue, preferably for a hydroxy residue,

R⁴ stands for H, a C₁₋₆-alkyl residue, a C₁₋₆-alkoxy residue, a C₁₋₆-alkylsulphonylamino residue, a possibly substituted C₁₋₆-alkanoylamino or benzoylamino residue, preferably for H or a C₁₋₃-alkyl residue,

10, compounds according to general formula X

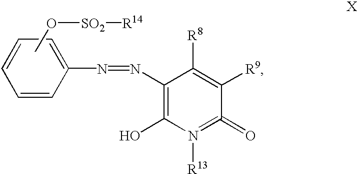

wherein

R⁸ stands for H or a C₁₋₆-alkyl residue, preferably for a methyl residue,

R⁹ stands for a cyano group or for a carbamoyl or acetyl residue, preferably for a cyano group,

R¹³ stands for H, a C₁₋₆-alkyl or C₁₋₆-alkoxy residue, preferably for a C₁₋₃-alkyl residue,

R¹⁴ stands for a phenyl residue possibly at least monosubstituted with halogen, a nitro or cyano group, preferably for an unsubstituted phenyl residue,

11, compounds according to general formula XI

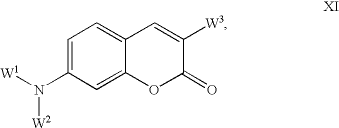

wherein

W¹ and W², which are identical or different, stand for a C₁₋₄-alkyl residue, preferably each for an ethyl residue,

W³ stands for a benzimidazole-2-yl, 5-chlorobenzoxazole-2-yl, benzothiazole-2-yl, 4-hydroxyquinazoline-2-yl or 5-phenyl-1,2,3-thiadiazole-2-yl residue,

12, compounds according to general formula XII

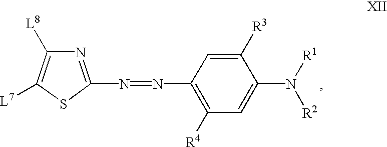

wherein

L⁷ stands for a nitro or cyano group, a C₁₋₆-alkanoyl, benzoyl, C₁₋₄-alkoxycarbonyl, C₁₋₆-alkylsulphonyl residue or a possibly substituted phenylsulphonyl residue, preferably for a nitro group,

L⁸ stands for H, a cyano group, a C₁₋₆-alkyl residue, a C₁₋₆-alkoxy residue possibly at least monosubstituted with a phenyl or C₁₋₄-alkoxy residue, a C₁₋₆-alkylthio residue possibly at least monosubstituted with a phenyl residue, a possibly substituted phenylthio residue, a C₁₋₆-alkylsulphonyl residue, a possibly substituted phenylsulphonyl residue or a C₁₋₄-alkoxycarbonyl residue, preferably for H,

R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue, preferably for a cyanoethyl, 2-phenylethyl, methoxycarbonylethyl or acetyloxyethyl residue,

R³ stands for H, a C₁₋₆-alkyl or C₁₋₆-alkoxy residue, preferably for H,

R⁴ stands for H, a C₁₋₆-alkyl residue, a C₁₋₆-alkoxy residue, a C₁₋₆-alkylsulphonylamino residue, a possibly substituted C₁₋₆-alkanoylamino or benzoylamino residue, preferably for a C₁₋₃-alkyl residue,

13, compounds according to general formula XIII

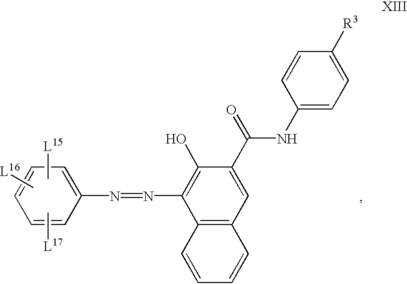

wherein

L¹⁵, L¹⁶ and L¹⁷, which are identical or different, stand for H, halogen, a nitro or cyano group, a C₁₋₆-alkyl residue, a C₁₋₆-alkoxy residue, a possibly substituted C₁₋₄-alkoxycarbonyl residue, a C₁₋₆-alkylsulphonyl residue, a possibly substituted phenylsulphonyl or phenylazo residue, preferably for H,

R³ stands for H, a C₁₋₆-alkyl or C₁₋₆-alkoxy residue, preferably for a methoxy residue,

Palanil® Cyanin B and Dispersol® Tiefrot SF.

If the substituents in general formulae I to XIII, above, stand for an alkyl or alkene residue, or contain a residue of this kind, these residues can be branched or unbranched in each instance. Unless otherwise stated, the alkyl residues can preferably be monosubstituted, particularly preferably monosubstituted or disubstituted. The substituents on the alkyl residues can preferably be selected from the group comprising cyclohexyl, phenyl, C₁₋₄-alkylphenyl, C₁₋₄-alkoxyphenyl, halogenphenyl, C₁₋₈-alkanoyloxy, C₁₋₈-alkylamino-carbonyloxy, C₁₋₂₀-alkoxycarbonyl, C₁₋₂₀-alkoxycarbonyloxy, cyclohexyloxy, phenoxy, halogen, hydroxy and cyano. The alkyl chain of the C₁₋₂₀-alkoxycarbonyl or C₁₋₂₀-alkoxycarbonyloxy residue possibly contains at least one ether group as a chain member in the alkyl chain and/or is possibly substituted with a phenyl or phenoxy residue.

If the substituents in general formulae I to XIII, above, display an alkyl or alkoxy residue with at least one ether group as a chain member in the alkyl chain, the maximum possible number of ether groups is dependent on the number of carbon atoms in the alkyl chain. Insofar as the alkyl chain contains a sufficient number of carbon atoms, alkyl residues of a kind displaying 1 to 4 ether groups, preferably 1 or 2 ether groups, as chain members are preferred.

If the substituents in general formulae I to XIII, above, stand for a substituted phenyl residue, or contain a residue of this kind, this can preferably be monosubstituted, disubstituted or trisubstituted, unless otherwise stated. The substituents on the phenyl residue can preferably be selected from the group comprising C₁₋₈-alkyl, C₁₋₈-alkoxy, halogen, preferably Br or Cl, a CN and a nitro group.

If one of residues L², L⁸, L¹⁵, L¹⁶, L¹⁷, R¹, R², R³, R⁴, R⁸, R¹⁰, R¹¹, R¹² and R¹³ in one of the above formulae stands for an alkyl residue, this can preferably be selected from the group comprising methyl, ethyl, propyl, isopropyl, butyl, isobutyl, sec-butyl, pentyl, isopentyl, neopentyl, tert-pentyl, hexyl and 2-methylpentyl.

If residue L² or L⁸ in one of the above formulae stands for an alkylthio residue or for a possibly substituted phenylthio residue, this can preferably be selected from the group comprising methylthio, ethylthio, propylthio, isopropylthio, butylthio, isobutylthio, pentylthio, hexylthio, benzylthio, 1-phenylethylthio, 2-phenylethylthio, phenylthio, 2-methylphenylthio, 2-methoxyphenylthio and 2-chlorophenylthio.

If one of residues L², L⁸, L¹⁵, L¹⁶, L¹⁷, R³ and R⁴ in one of the above formulae stands for an alkoxy residue, this is preferably selected from the group comprising methoxy, ethoxy, propoxy, isopropoxy, butoxy, isobutoxy, sec-butoxy, pentyloxy, isopentyloxy, neopentyloxy, tert. pentyloxy, hexyloxy and 2-methylpentoxy.

If one of residues L¹ L² L⁷ L⁸ L¹⁵ L¹⁶ L¹⁷ R¹⁰, R¹¹ and R¹² in one of the above formulae stands for an alkyl or phenylsulphonyl residue, this can preferably be selected from the group comprising methylsulphonyl, ethylsulphonyl, propylsulphonyl, isopropylsulphonyl, butylsulphonyl, isobutylsulphonyl, sec. butylsulphonyl, pentylsulphonyl, isopentylsulphonyl, neopentylsulphonyl, hexylsulphonyl, phenylsulphonyl, 2-methylphenylsulphonyl, 2-methoxyphenylsulphonyl and 2-chlorophenylsulphonyl.

If one of residues L³, L⁷, L⁸, L¹⁴, L¹⁵, L¹⁶ and L¹⁷ in one of the above formulae stands for an alkoxycarbonyl residue, this can preferably be selected from the group comprising methoxycarbonyl, ethoxycarbonyl, propoxycarbonyl, isopropoxycarbonyl, butoxycarbonyl, isobutoxycarbonyl and sec-butoxycarbonyl.

If one of residues L¹⁵, L¹⁶ and L¹⁷ in one of the above formulae stands for a substituted alkoxycarbonyl or phenylazo residue, this can preferably be selected from the group comprising 2-phenoxyethoxycarbonyl, 2-phenoxypropoxycarbonyl, 3-phenoxypropoxycarbonyl, 2-phenoxybutoxycarbonyl, 4-phenoxybutoxycarbonyl, 4-phenylazo, 4-nitrophenylazo and 2,4-dinitro-6-bromophenylazo.

If residue L² or L⁸ in one of the above formulae stands for an alkoxy residue substituted with an alkoxy residue or phenyl residue, this can preferably be selected from the group comprising 2-methoxyethoxy, 2-ethoxy-ethoxy, 2-methoxypropoxy, 3-methoxypropoxy, 2-ethoxypropoxy, 3-ethoxypropoxy, 2-methoxybutoxy, 4-methoxybutoxy, 2-ethoxybutoxy, 4-ethoxybutoxy, 5-methoxypentyloxy, 5-ethoxypentyloxy, 6-methoxyhexyloxy, 6-ethoxyhexyloxy, benzyloxy, 1-phenylethoxy and 2-phenylethoxy.

If one of residues R¹, R R¹¹, R¹² and R¹³ in one of the above formulae stands for a C₅₋₇-cycloalkyl residue, this can preferably stand for a cyclopentyl or cyclohexyl residue.

If one of residues L¹ and L⁷ in one of the above formulae stands for a C₁₋₆-alkanoyl residue, this can preferably be selected from the group comprising formyl, acetyl, propionyl, butyryl, isobutyryl, pentanoyl and hexanoyl.

If one of residues R¹⁰, R¹¹ and R¹² in one of the above formulae stands for a C₁₋₁₂-alkyl residue with possibly at least one ether grouping, this can preferably be selected from the group comprising heptyl, octyl, 2-ethylhexyl, nonyl, decyl, undecyl, dodecyl, 4,7-dioxanonyl, 4,8-dioxadecyl, 4,6-dioxaundecyl, 3,6,9-trioxaundecyl, 4,7,10-trioxaundecyl and 4,7,10-trioxadodecyl.

If one of residues R¹, R², R¹⁰, R¹¹ and R¹² in one of the above formulae stands for a possibly substituted alkyl residue with possibly at least one ether group as a chain member in the alkyl chain, this can preferably be selected from the group comprising 2-methoxyethyl, 2-ethoxyethyl, 2-propoxyethyl, 2-butoxyethyl, 2-isobutoxyethyl, 2-methoxypropyl, 3-methoxypropyl, 1-methoxyprop-2-yl, 2-ethoxypropyl, 3-ethoxypropyl, 2-propoxypropyl, 3-propoxypropyl, 3,6-dioxaheptyl, 3,6-dioxaoctyl, 4,7-dioxaoctyl, 2-hydroxyethyl, 3-hydroxypropyl, 4-hydroxybutyl, 2-phenoxyethyl, 2-phenoxypropyl, 4-phenoxybutyl, 2-cyanoethyl, 2-cyanopropyl, 3-cyanopropyl, 4-cyanobutyl, 1-phenylethyl, 2-phenylethyl, 2-acetyloxyethyl, 2-propioyloxyethyl, 2-acetyloxypropyl, 3-acetyloxypropyl and C₂H₄-O-C₂H₄-OH.

If one of residues R¹ R² R¹⁰, R¹¹ and R¹² in one of the above formulae stands for a C₁₋₄-alkoxycarbonyl-C₁₋₄-alkyl residue, this can preferably be selected from the group comprising 2-methoxycarbonylethyl, 2-ethoxycarbonylethyl, 2-methoxycarbonyl propyl 3-methoxycarbonylpropyl, 2-ethoxycarbonylpropyl, 3-ethoxycarbonylpropyl, 2-butoxycarbonylpropyl, 3-butoxycarbonylpropyl, 4-methoxycarbonylbutyl and 4-ethoxycarbonylbutyl.

If one of residues R¹, R², R¹⁰, R¹¹ and R¹² in one of the above formulae stands for a C₃₋₆-alkenyl residue, this can preferably be selected from the group comprising prop-2-ene-1-yl, 2-methyl-prop-2-ene-1-yl, but-2-ene-1-yl and but-3-ene-1-yl.

If one of residues R¹⁰, R¹¹ and R¹² in one of the above formulae stands for an alkanoyl residue or a possibly substituted benzoyl residue, this can preferably be selected from the group comprising formyl, acetyl, propionyl, butyryl, isobutyryl, pentanoyl, hexanoyl, heptanoyl, octanyl, 2-ethylhexanoyl, benzoyl, 2-methylbenzoyl, 3-methylbenzoyl, 4-methylbenzoyl, 2-methoxybenzoyl, 3-methoxybenzoyl, 4-methoxybenzoyl, 2-chlorobenzoyl, 3-chlorobenzoyl and 4-chlorobenzoyl.

If one of residues A¹, A² and A⁷ in one of the above formulae stands for an alkyl residue, this can preferably be selected from the group comprising methyl, ethyl, propyl, isopropyl, butyl, isobutyl, sec-butyl, tert-butyl, pentyl, isopentyl, neopentyl, tert-pentyl, hexyl, 2-methylpentyl, heptyl, 1-ethylpentyl, octyl, 2-ethylhexyl and isooctyl.

If residue A⁷ in one of the above formulae stands for an alkyl residue with at least one ether group, this can preferably be selected from the group comprising 2-methoxyethyl, 2-ethoxyethyl, 2-propoxyethyl, 2-isopropoxyethyl, 2-butoxyethyl, 2-isobutoxyethyl, 2-methoxypropyl, 3-methoxypropyl, 1-methoxyprop-2-yl, 2-ethoxypropyl, 3-ethoxypropyl, 2-propoxypropyl, 3-propoxypropyl, 2-butoxypropyl, 3-butoxypropyl, 2-methoxybutyl, 4-methoxybutyl, 2-ethoxybutyl, 4-ethoxybutyl, 2-propoxybutyl, 4-propoxybutyl, 3,6-dioxaheptyl, 3,6-dioxaoctyl, 4,8-dioxanonyl, 3,7-dioxaoctyl, 3,7-dioxanonyl, 4,7-dioxaoctyl, 4,7-dioxanonyl, 2-butoxybutyl, 4-butoxybutyl, 4,8-dioxadecyl, 3,6,9-trioxadecyl and 3,6,9-trioxaundecyl.

If residue G² stands for a monoalkylsulphamoyl residue, this can preferably be selected from the group comprising methylsulphamoyl, ethylsulphamoyl, propylsulphamoyl, isopropylsulphamoyl, butylsulphamoyl, pentylsulphamoyl, hexylsulphamoyl, heptylsulphamoyl, octylsulphamoyl and 4-oxahexylsulphamoyl.

If one of residues A¹ and A² in one of the above formulae stands for a possibly substituted phenyl residue, this can preferably be selected from the group comprising phenyl, 2-methylphenyl, 3-methylphenyl, 4-methylphenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-butylphenyl, 3-butylphenyl, 4-butylphenyl, 2,4-dimethylphenyl, 2-methoxyphenyl, 3-methoxyphenyl, 4-methoxyphenyl, 2-ethoxyphenyl, 3-ethoxyphenyl, 4-ethoxyphenyl, 2-propoxyphenyl, 3-propoxyphenyl, 4-propoxyphenyl, 2-butoxyphenyl, 3-butoxyphenyl, 4-butoxyphenyl, 2-isobutoxyphenyl, 3-isobutoxyphenyl, 4-isobutoxyphenyl, 2,4-dimethoxyphenyl and —C₆H₄—OCH₂—COOC₂H₄OC₂H₅.

If one of residues W¹ and W² in one of the above formulae stands for an alkyl residue, this can preferably be selected from the group comprising methyl, ethyl, propyl, isopropyl, butyl, isobutyl, sec-butyl and tert-butyl.

The above-mentioned disperse dyestuffs of general formulae I to XIII are known in themselves and can be manufactured by customary methods familiar to the person skilled in the art, or are commercially available on the market, e.g. under the names Dispersol®, Palanil®, Terasil®, Teratop®, Foron®, Dianixe or Serilen®. The disperse dyestuffs Palanil® Cyanin B and Dispersol® Tiefrot SF are also commercially available on the market.

The azo dyestuffs of the above general formulae II, VI, VII, VIII, IX, X, XII and XIII are described, for example, in Venkataraman “The Chemistry of Synthetic Dyes”, Vol. VI, Academic Press, New York, London 1972, or in EP-0-201 896. The corresponding descriptions are herewith introduced as a reference and are deemed part of the disclosure.

The anthraquinone dyestuffs of the above formulae IV and V are described, for example, in D. R. Waring, G. Hallas “The Chemistry and Application of Dyes”, pages 107-118, Plenum Press, New York, London, 1990. The corresponding literature description is herewith introduced as a reference and is deemed part of the disclosure.

The coumarin dyestuffs of the above formulae III and XI are described, for example, in “Ullmanns Enzyklopädie der technischen Chemie” (Ullmann's Encyclopaedia of Technical Chemistry), 4th Edition, Vol.17, page 469. The corresponding literature description is herewith introduced as a reference and is deemed part of the disclosure.

The benzodifuranone dyestuffs of the above formula I are described, for example, in Y. Ueda et al. “Sumikaron Brilliant Red S-BWF—a new benzodifuranone-type disperse dye” in Sumitomo Kayaku Shi, 1994-II, dated Nov. 29, 1994. The corresponding literature description is herewith introduced as a reference and is deemed part of the disclosure. Further benzodifuranone dyestuffs (Chemical Abstract Nos. 79694-17-0, 126877-05-2 and 126877-06-3) and their mixing are described, for example, in Committee on Ways and Means, Subcommittee on Trade, Hearing Advisory, 20 April 2000, No. TR-20. The corresponding literature description is herewith likewise introduced as a reference and is deemed part of the disclosure.

The nonwoven fabric used for colouring is preferably dyed and/or printed using at least one disperse dyestuff selected from the group comprising

1, the compound of general formula IV, wherein X stands for an oxygen atom and residue A⁷ for a 3-methoxypropyl residue,

2, the compound of general formula II, wherein L¹⁵ stands for a nitro group in 2-position, L¹⁶ for a nitro group in 4-position, L¹⁷ for a Br residue in 6-position, R¹ and R² each for a 2-acetyloxyethyl residue, R³ for a methoxy residue and R⁴ for an acetylamino residue,

3, the compound of general formula II, wherein L¹⁵ stands for a Cl residue in 2-position, L¹⁶ for a nitro group in 4-position, L¹⁷ for H in 6-position, R¹ and R² each for an acetyloxyethyl residue, R³ for H and R⁴ for an acetylamino residue,

4, the compound of general formula II, wherein L¹⁵ stands for a Cl residue in 2-position, L¹⁶ for a nitro group in 4-position, L¹⁷ for a Br residue in 6-position, R¹ and R² each for a methoxycarbonylethyl residue and R³ R⁴ each for H,

and Palanil® Leuchtrot B and Dispersol® Rubin XF.

Likewise preferred is a black or grey-dyed and/or printed nonwoven fabric, made of unsplit and/or at least partially split microfibres and/or microfilaments made of synthetic polymers containing at least one polyester component and at least one polyamide component and, possibly, at least one polyurethane component, which has been dyed and/or printed with a dyestuff mixture consisting of a red dyestuff, a yellow dyestuff and a blue dyestuff selected from the group of above-mentioned disperse dyestuffs.

Particularly preferred is a black or grey-dyed and/or printed nonwoven fabric, made of unsplit and/or at least partially split microfibres and/or microfilaments made of synthetic polymers containing at least one polyester component and at least one polyamide component and, possibly, at least one polyurethane component, which has been dyed and/or printed with a dyestuff mixture consisting of an orange dyestuff of the above general formula II, wherein L¹⁵ and L¹⁶ each stand for H, L¹⁶ for a nitro group in 4-position, R¹ for a —CH₂CH₂CN residue, R² for a —C₂H₄O—CO—CH₂—O-phenyl residue and R³ and R⁴ each for H, a red dyestuff of the above general formula 1, wherein A¹ stands for a phenyl residue and A² for a residue with the formula —C₆H₄—OCH₂—CO—OC₂H₄—OC₂H₅, or with Dianix® Dunkelrot AM-2B, and a blue dyestuff of the above general formula 11, preferably Dianix® Dunkelblau K-R or a blue dyestuff of general formula II, wherein L¹⁵ stands for a nitro group in 2-position, L¹⁶ for a nitro group in 4-position, L¹⁷ for a Br residue in 6-position, R¹ and R² each for a —CH₂—CH₂O—CO—CH₃ residue, R³ for an OCH₃ residue and R⁴ for a NHCOCH₃ residue.

In a preferred embodiment of the present invention, the nonwoven fabric used for colouring consists of unsplit and/or at least partially split microfibres and/or microfilaments made of at least one polyester component and at least one polyamide component, wherein these two components are preferably present in a ratio of 5 to 95% by weight polyester and 95 to 5% by weight polyamide, particularly preferably 15 to 85% by weight polyester and 85 to 15% by weight polyamide and most particularly preferably 30 to 70% by weight polyester and 70 to 30% by weight polyamide.

Polyester/polyamide microfibres and/or polyester/polyamide microfilaments of this kind can preferably be manufactured according to methods of the type described in EP 0 814 188. The corresponding description is herewith introduced as a reference and is deemed part of the disclosure.

The titre of the microfibres and/or microfilaments present in the nonwoven fabric is preferably ≦1 dtex.

The polyamide component of the nonwoven fabric preferably consists of polyamide 6, polyamide 66 or polyamide 11.

The polyester component of the nonwoven fabric preferably consists of polyethylene terephthalate, polypropylene terephthalate, polybutylene terephthalate, polylactic acid, their mixtures or copolyesters. Corresponding copolyesters can be obtained by partial substitution of either the acid component and/or the diol component during the manufacture of the polyester, as described, for example, in Buttner “Basisch modifizierte Polyesterfasern” (Basically Modified Polyester Fibres” in “Die Angewandte Makromolekulare Chemie” (Applied Macromolecular Chemistry) 40/41, 1974, pages 57 to 70 (No. 593) or G. G. Kulkarni, Colourage, 21 August 1986, pages 30 to 33. The corresponding literature descriptions are herewith introduced as a reference and are deemed part of the disclosure.

Likewise preferably, the nonwoven fabric used for dyeing can have a polyester component that is a polyester based on lactic acid, such as those described in EP 1 091 028. The corresponding description is herewith introduced as a reference and is deemed part of the disclosure.

In a particularly preferred embodiment of the present invention, the nonwoven fabric is a staple-fibre nonwoven or a spunbonded nonwoven made of unsplit and/or at least partially split microfibres and/or microfilaments. Nonwoven fabrics of this kind can be manufactured according to customary methods known to the person skilled in the art. Spunbonded nonwovens of this kind can preferably be manufactured according to methods of the type described in EP 0 814 188. The corresponding description is herewith introduced as a reference and is deemed part of the disclosure. The weight per unit area of the nonwoven fabric used for dyeing can vary over a wide range. The weight per unit area of the nonwoven fabric is preferably 15 to 350 g/m², particularly preferably 50 to 300 g/m² and most particularly preferably 80 to 200 g/m²

A further object of the present invention is a method for dyeing and/or printing the nonwoven fabric described, according to which the nonwoven fabric used for dyeing and/or printing is treated with at least one disperse dyestuff selected from the group comprising compounds of the above general formulae I to XIII, Palanil® Cyanin B and Dispersol® Tiefrot SF.

In a preferred embodiment of the method according to the invention, dyeing of the nonwoven fabric with one or more of the above-mentioned disperse dyestuffs is accomplished by the exhaust dyeing process, according to which the dyestuff goes onto the nonwoven fabric from the dye bath. If necessary, dyeing can also be performed in the presence of dyeing accelerators or carriers.

The dyeing temperature, dyeing time and pH value can vary over a wide range during dyeing according to the exhaust dyeing process. The dyeing temperature is preferably 60 to 145° C., particularly preferably 80 to 140° C. and most particularly preferably 120 to 135° C. The dyeing time is preferably 5 to 120 minutes, particularly preferably 20 to 60 minutes and most particularly preferably 25 to 45 minutes. The pH value is preferably adjusted to between 2 and 11. The pH value particularly preferably lies in the acid to neutral range, most particularly preferably between 4 and 6.

The dye bath is preferably subsequently cooled and, possibly, the dyed nonwoven fabric preferably washed with water.

Dyeing according to the exhaust dyeing process is customarily followed by final scouring by customary methods familiar to the person skilled in the art, preferably acid or alkaline, reductive final scouring, in order to remove excess or poorly adhering dyestuff. Alkaline, reductive final scouring is preferably performed, at a temperature of 60 to 150° C., preferably 80 to 85° C., using the customary quantities, familiar to the person skilled in the art, of base and reducing agent, such as sodium hydroxide and sodium hydrosulphite or thiourea dioxide.

Likewise preferred is the implementation of the method according to the invention in that, in a continuous process, one or more of the above-mentioned disperse dyestuffs are applied mechanically, e.g. by padding, to the nonwoven fabric used for colouring and migrate into the fibres under thermal treatment, possibly in the presence of steam, are dried and fixed. This method is also known to the person skilled in the art under the name of thermosol dyeing method.

Padding preferably takes place at a temperature of 5 to 100° C., particularly preferably 10 to 40° C. and most particularly preferably 15 to 30° C.

The fixation temperature and fixation duration can vary over a wide range during dyeing according to this method. The fixation temperature is preferably 80 to 240° C., particularly preferably 100 to 220° C. and most particularly preferably 150 to 210° C. The fixation time is preferably 1 second to 30 minutes, particularly preferably 15 seconds to 10 minutes and most particularly preferably 45 seconds to 5 minutes. Dyeing is customarily followed by final scouring by customary methods familiar to the person skilled in the art, preferably acid or alkaline, reductive final scouring. Alkaline, reductive final scouring is preferably performed, at a temperature of 60 to 150° C., preferably 80 to 85° C., using the customary quantities, familiar to the person skilled in the art, of base and reducing agent, such as sodium hydroxide and sodium hydrosulphite or thiourea dioxide.

If the nonwoven fabric is printed with one or more of the above-mentioned disperse dyestuffs, this can be accomplished according to customary methods familiar to the person skilled in the art. The corresponding printing paste can be manufactured by customary methods familiar to the person skilled in the art and preferably contains at least the selected disperse dyestuff(s) and a thickener.

Printing of the nonwoven fabric is preferably accomplished by a direct printing process, particularly preferably a rotary, screen of inkjet printing process, where the required pattern is printed onto the nonwoven fabric using a printing screen.

Likewise preferably, the printing of the nonwoven fabric is accomplished by means of a transfer printing process, where one or more of the above-mentioned disperse dyestuffs, possibly in the presence of dyeing accelerators (carriers) and/or other customary auxiliaries familiar to the person skilled in the art, such as wetting agents or antimigrants, are first padded or printed onto a transfer medium, such as paper, dried and then transferred to the nonwoven fabric under the effect of pressure and heat. The reaction time is preferably 1 second to 30 minutes, particularly preferably 10 seconds to 5 minutes and most particularly preferably 30 to 120 seconds. The temperature during the reaction is preferably 100 to 240° C., particularly preferably 150 to 220° C. and most particularly preferably 175 to 215° C. The suitable pressure and the suitable temperature can be determined by the person skilled in the art on the basis of simple preliminary trials.

Printing is customarily followed by final scouring by customary methods familiar to the person skilled in the art, preferably acid or alkaline, reductive final scouring. Alkaline, reductive final scouring is preferably performed, at a temperature of 60 to 150° C., preferably 80 to 85° C., using the customary quantities, familiar to the person skilled in the art, of base and reducing agent, such as sodium hydroxide and sodium hydrosulphite or thiourea dioxide.

The transfer printing process can also be carried out after pre-treatment of the nonwoven fabric used for printing with a dyeing accelerator (carrier) of the kind described, for example, in “Der neue THK-Textilhilfsmittel-Katalog 2000” (The New Textile Auxiliaries Catalogue 2000), Deutscher Fachverlag GmbH publishers, 1999, Frankfurt am Main, pages 86 to 88 or in “Rath-Lehrbuch der Textilchemie” (Rath Textbook of Textile Chemistry), 3rd Edition, Springer Verlag publishers, Berlin, Heidelberg, New York, 1972, pages 625 and 626. The corresponding literature descriptions are herewith introduced as a reference and are deemed part of the disclosure.

Use can preferably be made of the ecologically compatible, chloroaromatic-free carriers described there, based on polyglycol ethers, N-alkyl phthalimides, carboxylic acid compounds, fatty alcohol ethoxylates and alkylamides, alkylaryl sulphonates, aromatic hydrocarbons or mixtures of at least two of these compounds. In this context, the carrier is customarily padded onto the nonwoven fabric, dried and, possibly, set at temperatures of preferably 150 to 240° C., particularly preferably 175 to 215° C. The suitable quantity of the respective carrier can be determined by the person skilled in the art with the help of simple preliminary trials.

The nonwoven fabric pre-treated in this way can then be printed by the transfer printing process described above.

In many cases, pre-treatment with a carrier results in increased, and thus improved, depth of colour of the printed nonwoven fabric.

Fixation of the disperse dyestuff can, if necessary, be performed after intermediate drying of the nonwoven fabric, after padding or printing by the direct or transfer printing process, also with heated rolls at elevated temperatures. The temperature is preferably in the region of the softening point of the polymer used.

In order to obtain a pattern when printing the nonwoven fabric, it is also possible to treat the nonwoven fabric used with customary resist agents familiar to the person skilled in the art. As a result of the resist treatment, the dyestuff applied during printing is either not taken up or destroyed in the resist printed area, meaning that the required pattern is created when printing the nonwoven fabric.

The dyeing effect of the disperse dyestuffs and the fastness of the dyeing can vary as a function of the method used for dyeing or printing and the quantity of dyestuff used.

The suitable quantity of disperse dyestuff, and the corresponding conditions necessary in each case to achieve the required dyeing of the nonwoven fabric, can be determined by the person skilled in the art by means of simple preliminary trials.

Moreover, based on the properties of the disperse dyestuffs, the person skilled in the art is also familiar with which further auxiliaries can advantageously be added, depending on the dyeing or printing method used in each case. Suitable auxiliaries are described, for example, in the corresponding sample cards of the dyestuff manufacturers and in “Der neue THK-Textilhilfsmittelkatalog 2000” (The New Textile Auxiliaries Catalogue 2000), Deutscher Fachverlag GmbH publishers, 1999, Frankfurt am Main, pages 57 to 140. The corresponding description is herewith introduced as a reference and is thus deemed part of the disclosure.

The nonwoven fabrics used according to the invention often display undesirable shrinkage, such as washing or ironing shrinkage. In order to reduce or completely suppress shrinkage, the nonwoven fabric can be treated at temperatures of preferably 60 to 130° C. under mechanical action. To this end, the undyed nonwoven fabric can initially be treated continuously or batchwise in the form of a hank. This treatment can preferably be performed as aftertreatment at a temperature of preferably 60 to 130° C. following dyeing and/or printing with the above-mentioned disperse dyestuffs. Particularly preferably, this treatment is carried out simultaneously with the dyeing or reductive scouring of the nonwoven fabric dyed and/or printed with one or more of the above-mentioned disperse dyestuffs.

The treatment can be followed by preferably low-tension or relaxed drying of the nonwoven fabric. This can optionally be done without lateral guidance in a continuous process or as a hank in a tumbler in a batchwise process.

In another preferred embodiment of the method according to the invention, aftertreatment with a dye fastness-improving agent is performed after the dyeing or printing of the nonwoven fabric, or after reductive scouring, or during or after finishing of the nonwoven fabric, or after it has been made up.

The use of an agent of this kind can further improve the dye fastness, particularly the wet fastness of the dyed or printed nonwoven fabric.

Surprisingly, it was found that this aftertreatment with a dye fastness-improving agent leads to improved dye fastness, particularly to improved wet fastness, such as washing, perspiration and water fastness, not only with the disperse dyestuffs used according to the invention and the nonwoven fabric used for colouring according to the invention, but also for all textile materials made of a synthetic polymer or mixtures of different synthetic polymers. Improved dye fastness was also found with other disperse dyestuffs, such as small-molecule disperse dyestuffs.

Suitable agents used for improving the dye fastness are preferably compounds selected from the group comprising possibly substituted arylsulphonic acids, hydroxyarylsulphonic acids, arylsulphonates, hydroxyarylsulphonates, alkylarylsulphonates, polycondensed functional amines, monomeric or polymeric quaternary ammonium compounds and, possibly, their corresponding condensation products. These are described, for example, in “Der neue THK-Textilhilfsmittelkatalog 2000” (The New Textile Auxiliaries Catalogue 2000), Deutscher Fachverlag GmbH publishers, 1999, Frankfurt am Main, pages 98-109 and 132-134. The corresponding description is herewith introduced as a reference and is deemed part of the disclosure. Suitable representatives of these compounds are commercially available on the market, under the names Mesitol®, Zetesal®, Nylofixan®, Cibatex®, Solfix®, Tinofix®, Lyocol® and Levegal®, for example.

The agent used to improve the dye fastness is preferably added in a quantity of 0.1 to 15% by weight, preferably 2 to 5% by weight, referred to the nonwoven fabric or other textile material used, to the rinsing bath that follows dyeing and/or printing with the above-mentioned disperse dyestuffs or scouring. The rinsing bath preferably has a temperature of 20 to 150° C., particularly preferably 40 to 70° C. The duration of the rinsing procedure is preferably 1 to 150 minutes, particularly preferably 20 to 100 minutes.

Alternatively, treatment with the dye fastness-improving agent can also be carried out during the finishing process, in which case the agent is preferably integrated into the finishing liquor. In this case, the agent is preferably added to the liquor in a quantity of 0.1 to 100 g/l liquor, particularly preferably in a quantity of 20 to 50 g/l liquor.

Preferably, in order to intensify the improvement of dye fastness by the agent, heat treatment can be carried out, preferably at a temperature of 70 to 150° C. This can, for example, also be done during the drying of the nonwoven fabric or during the fixing of the finishing chemicals.

In another preferred embodiment of the method according to the invention, the dyeing or printing of the nonwoven material with at least one of the above-mentioned disperse dyestuffs, with the exception of dyestuff mixtures containing Dispersol® Tiefrot SF, Dispersol® Marine XF and possibly Dispersol® Gelbbraun XF, can be supplemented by additional dyeing or printing of the polyamide component with a dyestuff selected from the group comprising vat dyestuffs, leuco vat dyestuffs, sulfur dyestuffs and soluble sulfur dyestuffs according to customary methods familiar to the person skilled in the art. Dyeing with the different classes of dyestuffs can preferably also take place in a single dye bath.

Suitable vat dyestuffs, leuco vat dyestuffs, sulfur dyestuffs and soluble sulfur dyestuffs are familiar to the person skilled in the art.

In order to increase the depth of colour, dyeing or printing can be followed by treatment of the dyed or printed nonwoven fabric with a colour-intensifying auxiliary as part of the finishing process. The colour-intensifying agents open to consideration in this context include all chemicals which change the angle of refraction of the light on the surface of the nonwoven fabric, e.g. by forming a film, in such a way that the refractive index between the air and the nonwoven fabric displays a value greater than 1. Suitable chemicals include, for example, polyacrylates, polyurethanes and polysiloxanes, which are also commercially available on the market under the names Badena® Eco 282, Finistrole KSE-D, Baypret® USV and Arristan® 64.

If the film formed consists of chemicals that also protect the dyestuffs against external influences, as in the case of Badena® Eco 282, for example, an improvement in dye fastness can also be achieved at the same time. The colour-intensifying auxiliary can be applied by customary methods familiar to the person skilled in the art. Preferably, the colour-intensifying auxiliary can be applied to the textile material, preferably the nonwoven fabric used according to the invention, with the help of the padding method at a pH value of 2 to 12, preferably 3 to 9, particularly preferably 4 to 8, and fixed at temperatures of 40 to 180° C., preferably 100 to 160° C., for a period of 1 second to 120 minutes, preferably 5 seconds to 45 minutes, particularly preferably 30 seconds to 2 minutes. The quantity of colour-intensifying agent suitable in each case can vary and can be determined by the person skilled in the art by means of simple preliminary trials. For Badena® Eco 282, the suitable quantity is preferably 10 to 100 g/l liquor, particularly preferably 20 to 50 g/l liquor.

In this context, the finishing liquor can contain not only the colour-intensifying auxiliary, but also other auxiliaries familiar to the person skilled in the art, such as stiffening agents, softening agents, crease-resistance finishing additives, hydrophilising agents, antistatic agents, water repellents or oil-repellents, such as described, for example, in “Der neue THK-Textilhilfsmittelkatalog 2000” (The New Textile Auxiliaries Catalogue 2000), Deutscher Fachverlag GmbH publishers, 1999, Frankfurt am Main, pages 141-261. The corresponding description is herewith introduced as a reference and is deemed part of the disclosure. In addition, the finishing liquor can also contain the fastness-improving agents described above.

The nonwoven fabric printed and/or dyed according to the invention, made of unsplit and/or at least partially split microfibres and/or microfilaments made of synthetic polymers containing at least one polyester component and at least one polyamide component and, possibly, at least one polyurethane component, is characterised by good colour levelness, adequate dye fastness even after heat treatment, particularly wash, perspiration, water and rub fastness, as well as adequate fastness to dry cleaning, and by good depth of colour. The wash fastness of the nonwoven fabric dyed and/or printed according to the invention was determined in accordance with EN ISO 105 C06 A2S, the perspiration fastness in accordance with EN ISO 105 E04, the water fastness in accordance with EN ISO 105 E01, the rub fastness in accordance with EN ISO 105 X12, the light fastness in accordance with EN ISO 105 B02 and the fastness to dry cleaning in accordance with EN ISO 105 D01. The corresponding descriptions are herewith introduced as a reference and are thus deemed part of the disclosure.

The K/S value at the absorption maximum of the dyeings is taken as a measure of the depth of colour of the dyeings. Using the Kubelka-Munk formula, this can be calculated from the reflectance values as follows:

$$\frac{K}{S} ( {λ}_{max} ) = \frac{{( 1 - R )}^{2}}{2 R}$$

wherein

λₘₐₓ Wavelength in the absorption maximum

R Reflectance value in the absorption maximum (λₘₐₓ)

The reflectance values R were measured with a Type Coloraflash C22S colorimeter from Messrs. Optronik.

The invention is explained below on the basis of examples. These explanations are merely exemplary and do not restrict the general idea of the invention.

### EXAMPLES

### Example 1

A spunbonded nonwoven, consisting of partially split microfilaments made of 70% by weight polyethylene terephthalate and 30% by weight polyamide 66 with a weight per unit area of 100 g/m² and a titre of approx. 0.15 dtex, was dyed in a one-stage exhaust dyeing process at a liquor ratio of 1:10 with 2% by weight (referred to the weight of the nonwoven fabric used) of the disperse dyestuff Teratop® Blau BGE (disperse dyestuff of general formula IV, wherein X stands for O and A⁷ for a 3-methoxypropyl residue, Colour Index: Disperse Blue 60). To this end, the dyestuff was dispersed with 2 g/l liquor of a dispersing agent based on a fatty amine ethoxylate and 1 g/l liquor of a sequestering agent based on an organic acid and salts. The pH value was adjusted to pH 4.5 with ammonium acetate/acetic acid. This was followed by heating to 130° C. at a rate of 1.5° C. per minute, dyeing at this temperature for 45 minutes and cooling to 80° C. at a rate of 1.5° C. per minute. The dyed nonwoven fabric was then rinsed for 5 minutes under cold, running water. This was followed by reductive scouring with 6 ml/l liquor of a 32% by weight sodium hydroxide solution and 2 g/l liquor sodium hydrosulphite at 85° C. for 20 minutes. This was followed by renewed rinsing with cold water, neutralisation with acetic acid and renewed rinsing with cold water for 1 minute.

In order to intensify the colour, finishing was carried out with 40 g/l of the polysiloxane compound Finistrol® KSE-D and 40 g/l of a hydrophilising agent based on amino-modified silicone-polyether copolymers. The dye fastness after heat treatment at 180° C. for 1 minute, which is intended to demonstrate the resistance of the dyeing to sublimation, and the colour intensification resulting from the aftertreatment are presented in Table 1, below.

### Example 2

A spunbonded nonwoven, consisting of partially split microfilaments made of 70% by weight polyethylene terephthalate and 30% by weight polyamide 66 with a weight per unit area of 100 g/m² and a titre of approx. 0.15 dtex, was dyed by the padding method with a liquor containing 2 g/l liquor of a wetting agent based on an alkyl phosphate, 10 g/l liquor of an antimigrant based on acrylic copolymers and 60 g/l liquor of the disperse dyestuff Palanil® Leuchtrot B. The pH value was adjusted to 6.5 with acetic acid. The liquor pickup was 100%. After padding, the dyed nonwoven fabric was dried at 130° C. for 1 minute and subsequently thermosoled at 215° C. for 60 seconds. This was followed by rinsing of the dyed nonwoven fabric for 5 minutes under cold, running water and by reductive scouring with 6 ml/l liquor of a 32% by weight sodium hydroxide solution and 2 g/l liquor sodium hydrosulphite at 85° C. for 20 minutes. This was followed by renewed rinsing with cold water, neutralisation with acetic acid and renewed rinsing with cold water for 1 minute.

The dye fastness after heat treatment at 180° C. for 1 minute, which is intended to demonstrate the resistance of the dyeing to sublimation, is presented in Table 1, below.

### Example 3

A spunbonded nonwoven, consisting of partially split microfilaments made of 70% by weight polyethylene terephthalate and 30% by weight polyamide 66 with a weight per unit area of 100 g/m² and a titre of approx. 0.15 dtex, was printed on one side by the direct printing process using a printing paste containing 975 g/kg of a stock paste consisting of 500 g/kg of a natural alginate thickener, 10 g/kg of a mild oxidant based on nitrobenzene sulphonate, 12 g/kg of a fixing agent based on alkylamide and 4 g/kg of an antifoam based on alcohol, as well as 474 g/kg water and 25 g/kg of the disperse dyestuff Palanil® Marineblau 3GR-CF (disperse dyestuff of general formula II, wherein L¹⁵ stands for a nitro group in 2-position, L¹⁶ for a nitro group in 4-position, L¹⁷ for a Br residue in 6-position, R¹ and R² each for a 2-acetyloxyethyl residue, R³ for a methoxy residue and R⁴ for an acetylamino residue, Colour Index: Disperse Blue 79.1). Fixing was carried out with hot air at 200° C. for 90 seconds.

Reductive scouring was performed with 6 ml/l liquor of a 32% by weight sodium hydroxide solution and 2 g/l liquor sodium hydrosulphite at 85° C. for 20 minutes. This was followed by renewed rinsing with cold water, neutralisation with acetic acid and renewed rinsing with cold water for 1 minute.

In order to intensify the colour, the dyed nonwoven fabric was subsequently padded with a liquor containing 25 g/l liquor of the polyacrylate Badena® Eco 282, at pH 6, adjusted with acetic acid. The wet pickup was 100% by weight. This was followed by drying at 100° C. for 120 seconds and fixing at 150° C. for 60 seconds.

The dye fastness after heat treatment at 180° C. for 1 minute, which is intended to demonstrate the resistance of the dyeing to sublimation, and the colour intensification resulting from the aftertreatment are presented in Table 1, below.

### Example 4

A spunbonded nonwoven, consisting of partially split microfilaments made of 70% by weight polyethylene terephthalate and 30% by weight polyamide 66 with a weight per unit area of 100 g/m² and a titre of approx. 0.15 dtex, was padded with a liquor containing 40 g/l liquor of a carrier based on an N-alkylphthalimide/carboxylic acid ester preparation. The wet pickup was approx. 100% by weight. This was followed by drying at 110° C. for 150 seconds and fixing at 180° C. for 60 seconds. The nonwoven fabric treated in this way was moulded at a pressure of 1.2 bar and a temperature of 210° C. for 45 seconds with a backing material made of 100% viscose, which had previously been padded in the thermosol process with a liquor consisting of 2 g/l liquor of a wetting agent based on an alkyl phosphate, 10 g/l liquor of an antimigrant based on acrylic copolymers and 60 g/l liquor of the disperse dyestuff Palanil® Rot 3 BLS-CF (disperse dyestuff of general formula II, wherein L¹⁵ stands for Cl in 2-position, L¹⁶ for a nitro group in 4-position, L¹⁷ for H in 6-position, R¹ and R² each for an acetyloxyethyl residue, R³ for H and R⁴ for an acetylamino residue, Colour Index: Disperse Red 167.1) at pH 6 (adjusted with acetic acid) (liquor pickup approx. 150% by weight) and subsequently dried at 110° C. for 150 seconds. Reductive scouring was then performed with 6 ml/l liquor of a 32% by weight sodium hydroxide solution and 2 g/l liquor sodium hydrosulphite at 85° C. for 20 minutes. This was followed by renewed rinsing with cold water, neutralisation with acetic acid and renewed rinsing with cold water for 1 minute.

The dye fastness after heat treatment at 180° C. for 1 minute, which is intended to demonstrate the resistance of the dyeing to sublimation, is presented in Table 1, below.

### Example 5

A spunbonded nonwoven, consisting of partially split microfilaments made of 35% by weight polyamide 66 and 65% by weight polyethylene terephthalate, is dyed in a one-stage exhaust dyeing process with the sublimation-resistant disperse dyestuff Dispersol® Rubin XF (mixture of at least two red dyestuffs of general formula 11). To this end, the disperse dyestuff is stirred into 1 g/l liquor of the wetting agent Sandacid® PB (Clariant) and 2 g/l of the dispersing agent Sandogen® EDP (Clariant). The pH value is adjusted to 4.5 with acetic acid. The liquor ratio is 1:10. Dyeing takes place at 130° C. for 45 minutes. This is followed by reductive scouring with sodium dithionite. The disperse dyeing is treated with 3% Mesitol® NBSJ (Bayer) at 70° C. for 20 minutes. Finally, rinsing is performed with cold water.

Compared to an untreated dyeing, the dyeing treated with Mesitol® NBSJ achieves substantially better dye fastness values after heat treatment at 180° C. for 1 minute, as indicated in Table 2.

### Example 6

A spunbonded nonwoven, consisting of partially split microfilaments made of 35% by weight polyamide 66 and 65% by weight polyethylene terephthalate, is dyed in a one-stage exhaust dyeing process with the disperse dyestuff Dispersol® Rubin XF (mixture of at least two red dyestuffs of general formula 11) and Indanthren® Rot FBB. This is followed by reductive scouring with sodium dithionite. After heat treatment at 180° C. for 1 minute, this being intended to simulate the temperature during finishing, the dyeing is subsequently treated with 3% Mesitol® NBSJ at 70° C. for 20 minutes in the exhaust dyeing process. The dye fastness of the heated dyeing before and after Mesitol treatment is given in Table 2.

### Example 7

A spunbonded nonwoven, consisting of partially split microfilaments made of 35% by weight polyamide 66 and 65% by weight polyethylene terephthalate, is dyed in a one-stage exhaust dyeing process with the disperse dyestuff Dispersol® Gelbbraun XF (disperse dyestuff of general formula II, wherein L¹⁵ stands for a Cl residue in 2-position, L¹⁶ for a nitro group in 4-position, L¹⁷ for a Br residue in 6-position, R¹ and R² each for a methoxycarbonylethyl residue and R³ and R⁴ each for H, Colour Index: Disperse Brown 19). This is followed by reductive scouring with sodium dithionite. After that, 50 g/l Mesitol® NBSJ are padded with the finishing liquor, dried at 100° C. for 3 minutes and fixed at 120° C. for 1 minute. The fastness after heat treatment at 180° C. for 1 minute, which is intended to demonstrate the improved heat resistance of the dyeings, is given in Table 2.

### Example 8

A spunbonded nonwoven, consisting of partially split microfilaments made of 35% by weight polyamide 66 and 65% by weight polyethylene terephthalate, is printed with the disperse dyestuff Teratop® Blau BGE (disperse dyestuff of general formula IV, wherein X stands for 0 and A⁷ for a 3-methoxypropyl residue, Colour Index: Disperse Blue 60, Ciba Spezialitätenchemie). This is followed by reductive scouring with sodium dithionite. The disperse dyeing is subsequently treated with 3% Mesitol® NBSJ at 70° C. for 20 minutes. Finally, rinsing is performed with cold water.

The fastness after heat treatment at 180° C. for 1 minute, which is intended to demonstrate the improved heat resistance of the dyeings, is given in Table 2.

### Example 9

A spunbonded nonwoven, consisting of partially split microfilaments made of 35% by weight polyamide 66 and 65% by weight polyethylene terephthalate, which has been dyed with disperse and vat dyestuff (Dispersol® Rubin XF, mixture of at least two red dyestuffs of general formula 11, Indanthren® Rot FBB), is treated with 3% Mesitol® NBSJ at 50° C. for 20 minutes. The fastness after heat treatment at 180° C. for 1 minute, which is intended to demonstrate the improved heat resistance of the dyeing, is given in Table 2.

TABLE 1
Dye fastness

| | Washing, | Perspiration, | Perspiration, | | | |
|---|---|---|---|---|---|---|
| | 40° C. | acidic | alkaline | Water | Dry cleaning | Rub fastness |
| | EN ISO 105 | EN ISO 105 | EN ISO 105 | EN ISO 105 | EN ISO 105 | EN ISO 105 |
| | C06-A2S | E04 | E04 | E01 | D01 | X 12 |
| Example 1 | 3-4S/4C | 4S/4C | 4S/4-5C | 4S/4-5C | 4-5S/4-5C | 4-5 dry |
| Teratop ® Blau BGE | | | | | | 4-5 wet |
| Example 2 | 4S/4C | 4S/3-4C | 4S/3-4C | 4S/4C | 4-5S/4C | 4-5 dry |
| Palanil ® Leuchtrot B | | | | | | 4-5 wet |
| Example 3 | 4S/4C | 4-5S/4C | 4S/4C | 4-5S/4-5C | 4S/4C | 4-5 dry |
| Palanil ® Marineblau | | | | | | 4-5 wet |
| 3GR-CF | | | | | | |
| Example 4 | 4S/4C | 4-5S/4-5C | 4-5S/4-5C | 4-5S/4-CC | 4S/3-4C | 4-5 dry |
| Palanil ® Rot3BLS-CF | | | | | | 4-5 wet |

Rating 5 = Very good;
Rating 1 = Very poor
S = Staining of multi-fibre accompanying fabric // C = Change of colour in the sample

Colour intensification

| | | K/S value after |
|---|---|---|
| | K/S value prior to treat- | treatment with |
| | ment with the colour- | the colour- |
| | intensifying auxiliary | intensifying auxiliary |
| Example 1 | 2.0 (at λₘₐₓ = 680 nm) | 2.4 (at λₘₐₓ = 680 nm) |
| Teratop ® Blau BGE | | |
| Example 3 | 4.2 (at λₘₐₓ = 618 nm) | 4.8 (at λₘₐₓ = 618 nm) |
| Palanil ® Marineblau | | |
| 3 GR-CF | | |

TABLE 2
Comparison of the dye fastness of untreated and treated dyeings:

| | Example 5 | | Example 7 | | Example 8 | | Example 9 | | Example 6 | |
|---|---|---|---|---|---|---|---|---|---|---|
| | Colour: red violet | | Colour: orange | | Colour: blue | | Colour: red | | Colour: red violet | |
| | Untreated | Treated | Untreated | Treated | Untreated | Treated | Untreated | Treated | Untreated | Treated |
| Washing, 40° C. | 3-4S/4C | 4S/4C | 3-4S/3-4C | 4S/3-4C | 3S/4C | 4S/4C | 4-5S/4-5C | 4-5S/4-5C | 3-4S/4C | 4S/4C |
| EN ISO 105 | | | | | | | | | | |
| C06-A2S | | | | | | | | | | |
| Water | 4S/4C | 4-5S/4C | 3-4S/4C | 4-5S/4C | 4S/4-5C | 4-5S/4-5C | 3S/4-5C | 4S/4-5C | 4S/4C | 4-5S/4C |
| EN ISO 105 E01 | | | | | | | | | | |
| Perspiration, | 3-4S/4C | 4S/4C | 3-4S/4C | 4-5S/4C | 4S/4C | 4-5S/4C | 3-4S/4C | 4-5S/4C | 3-4S/4C | 4S/4C |
| acidic EN ISO | | | | | | | | | | |
| 105 E04 | | | | | | | | | | |
| Perspiration, | 3S/4C | 3-4S/4C | 3S/3-4C | 4S/3-4C | 4S/4C | 4-5S/4C | 3S/4-5C | 4S/4-5C | 3-4S/4C | 4S/4C |
| alkaline EN ISO | | | | | | | | | | |
| 105 E04 | | | | | | | | | | |

Rating 5 = Very good;
Rating 1 = Very poor
S = Staining of accompanying fabric // C = Change of colour in the sample

### Example 5

Colour: red violet

1.10% Dispersol® Rubin XF

### Example 7

Colour: orange

1.20% Dispersol® Gelbbraun XF (BASF)

### Example 8

Colour: blue

2.00% Teratop® Blau BGE (Ciba)

### Example 9

Colour: red

1.10% Dispersol® Tiefrot SF (BASF)

3.00% Indanthren® Rot FBB (BASF)

### Example 6

Colour: red violet

1.10% Dispersol® Rubin XF

3.00% Indanthren® Rot FBB (BASF)

1. Dyed and/or printed nonwoven fabric made of unsplit and/or at least partially split microfibres and/or microfilaments made of synthetic polymers containing at least one polyester component and at least one polyamide component and, possibly, at least one polyurethane component, characterised in that it has been dyed and/or printed with at least one disperse dyestuff selected from the group comprising
1, compounds according to general formula I 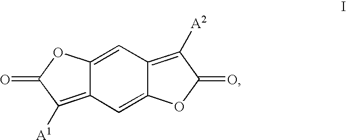
wherein
A¹ and A², which are identical or different, stand for H, a C₁₋₈-alkyl residue or a possibly substituted phenyl residue,
2, compounds according to general formula II 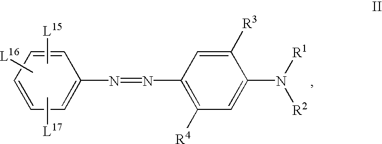
wherein
L¹⁵, L¹⁶ and L¹⁷, which are identical or different, stand for H, halogen, a C₁₋₆-alkyl or C₁₋₆-alkoxy residue, a nitro or cyano group, a C₁₋₆-alkylsulphonyl residue or for a possibly substituted C₁₋₄-alkoxycarbonyl, phenylsulphonyl or phenylazo residue,
R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue,
R³ stands for H, a C₁₋₆-alkyl or C₁₋₆-alkoxy residue,
R⁴ stands for H, a C₁₋₆-alkyl residue, a C₁₋₆-alkoxy residue, a C₁₋₆-alkylsulphonylamino residue, or for a possibly substituted C₁₋₆-alkanoylamino or benzoylamino residue,
3, compounds according to general formula Ill 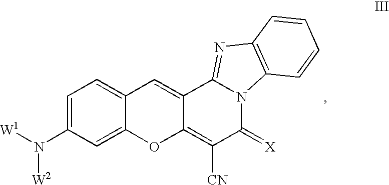
wherein
W¹ and W², which are identical or different, stand for a C₁₋₄-alkyl residue,
X stands for an oxygen atom, a sulphur atom or an imino group,
4, compounds according to general formula IV 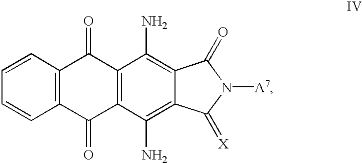
wherein
A⁷ stands for H or for a C₁₋₈-alkyl residue with possibly at least one ether group as a chain member in the alkyl chain,
X stands for an oxygen atom, a sulphur atom or an imino group,
5, compounds according to general formula V 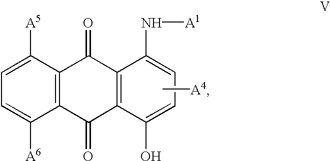
wherein
A¹ stands for H, a C₁₋₈-alkyl residue or for a possibly substituted phenyl residue,
A⁴ stands for halogen, a hydroxyphenyl, phenoxy, C₁₋₄-alkoxyphenyl or 1-oxyhexan-6-ol-(—O—C₆H₁₂—OH) residue or for the group para-G¹-phenylene-G², wherein G¹ stands for an oxygen or sulphur atom and G² for a C₁₋₈-monoalkylsulphamoyl residue, whose alkyl chain possibly displays at least one ether group as a chain member,
one of residues A⁵ and A⁶ stands for a hydroxyl residue and the other residue A⁵ or A⁶ means the group NH-A¹′, wherein A¹ stands for H, a C₁₋₈-alkyl residue or a possibly substituted phenyl residue,
or residues A⁵ and A⁶ each stand for H,
6, compounds according to general formula VI 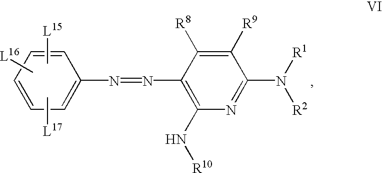
wherein
L¹⁵, L¹⁶ and L¹⁷, which are identical or different, stand for H, halogen, a C₁₋₆-alkyl, C₁₋₆-alkoxy or C₁₋₆-alkylsulphonyl residue, a nitro or cyano group, or for a possibly substituted C₁₋₄-alkoxycarbonyl, phenylsulphonyl or phenylazo residue,
R⁸ stands for H or a C₁₋₆-alkyl residue,
R⁹ stands for a carbamoyl or acetyl residue, or for a cyano group,
R¹⁰, R¹¹ and R¹², which are identical or different, stand for H, a possibly substituted C₁₋₁₂-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted phenyl or benzyl residue, a C₃₋₆-alkenyl residue, a possibly substituted benzoyl residue, a C₁₋₈-alkanoyl, C₁₋₆-alkylsulphonyl or a possibly substituted phenylsulphonyl residue,
or residues R¹¹ and R¹², together with the nitrogen atom connecting them, stand for a 5 or 6-membered, saturated ring system with possibly at least one further heteroatom,
7, compounds according to general formula VII 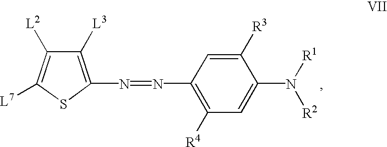
wherein
L¹ stands for a nitro or cyano group, for a C₁₋₆-alkanoyl, benzoyl, C₁₋₆-alkylsulphonyl residue or for a possibly substituted phenylsulphonyl residue,
L² stands for H, a C₁₋₆-alkyl, halogen, hydroxy or mercapto residue, a C₁₋₆-alkoxy residue possibly at least monosubstituted with a phenyl or C₁₋₄-alkoxy residue, a possibly substituted phenoxy residue, a C₁₋₆-alkylthio residue possibly at least monosubstituted with a phenyl residue, a possibly substituted phenylthio residue, a C₁₋₆-alkylsulphonyl residue or for a possibly substituted phenylsulphonyl residue,
L³ stands for H, a cyano or nitro group, or for a C₁₋₄-alkoxycarbonyl residue,
R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue,
R³ stands for H, a C₁₋₆-alkyl or C₁₋₆-alkoxy residue,
R⁴ stands for H, a C₁₋₆-alkyl residue, a C₁₋₆-alkoxy residue, a C₁₋₆-alkylsulphonylamino residue, or for a possibly substituted C₁₋₆-alkanoylamino or benzoylamino residue,
8, compounds according to general formula VIII 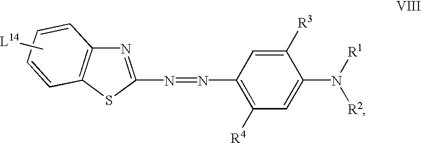
wherein
L¹⁴ stands for H, halogen, a cyano, —SCN or nitro group, or for a C₁₋₄-alkoxycarbonyl residue,
R¹ and R², which are identical or different, stand for H, a possibly substituted C₁₋₆-alkyl residue with possibly at least one ether group as a chain member in the alkyl chain, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue,
R³ stands for H, a C₁₋₆-alkyl or C₁₋₆-alkoxy residue,
R⁴ stands for H, a C₁₋₆-alkyl residue, a C₁₋₆-alkoxy residue, a C₁₋₆-alkylsulphonylamino residue, or for a possibly substituted C₁₋₆-alkanoylamino or benzoylamino residue,
9, compounds according to general formula IX 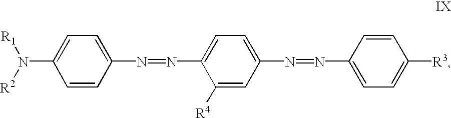
wherein
R¹ and R², which are identical or different, stand for H, a possibly substituted C₁₋₆-alkyl residue with possibly at least one ether group as a chain member in the alkyl chain, a C₁₋₄-alkoxycarbonyl residue, a C₁₋₄-alkoxycarbonyl-C₁₋₄-alkyl residue, an aryloxy-C₁₋₄-alkylcarbonyloxy-C₁₋₄-alkyl residue, a C₁₋₄-alkoxycarbonyloxy-C₁₋₄-alkyl residue, a C₅₋₇-cycloalkyl residue, a possibly substituted benzyl residue or a C₃₋₆-alkenyl residue,
R³ stands for H, a hydroxy, C₁₋₆-alkyl or C₁₋₆-alkoxy residue,
R⁴ stands for H, a C₁₋₆-alkyl residue, a C₁₋₆-alkoxy residue, a C₁₋₆-alkylsulphonylamino residue, or for a possibly substituted C₁₋₆-alkanoylamino or benzoylamino residue,
10, compounds according to general formula X 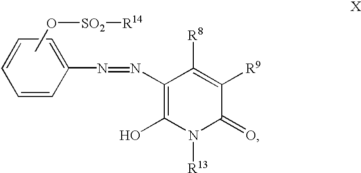
wherein
R⁸ stands for H or a C₁₋₆-alkyl residue,
R⁹ stands for a cyano group, or for a carbamoyl or acetyl residue,
R¹³ stands for H, a C₁₋₆-alkyl or C₁₋₆-alkoxy residue,
R¹⁴ stands for a phenyl residue possibly at least monosubstituted with halogen, a nitro or cyano group,
11, compounds according to general formula XI 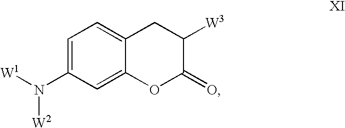
wherein
W¹ and W², which are identical or different, stand for a C₁₋₄-alkyl residue and W³ for a benzimidazole-2-yl, 5-chlorobenzoxazole-2-yl, benzothiazole-2-yl, 4-hydroxyquinazoline-2-yl or 5-phenyl-1,2,3-thiadiazole-2-yl residue,
12, compounds according to general formula XII 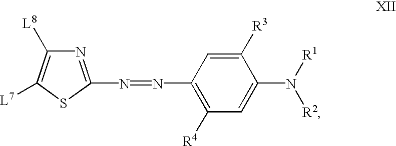
wherein
L⁷ stands for a nitro or cyano group, a C₁₋₆-alkanoyl, benzoyl, C₁₋₄-alkoxycarbonyl, C₁₋₆-alkylsulphonyl residue or a possibly substituted phenylsulphonyl residue,
L⁸ stands for H, halogen, a cyano group, a C₁₋₆-alkyl residue, a C₁₋₆-alkoxy residue possibly at least monosubstituted with a phenyl or C₁₋₄-alkoxy residue, a C₁₋₆-alkylthio residue possibly at least monosubstituted with a phenyl residue, a possibly substituted phenylthio residue, a C₁₋₆-alkylsulphonyl residue, a possibly substituted phenylsulphonyl residue or a C₁₋₄-alkoxycarbonyl residue,
R¹ and R², which are identical or different, stand for H, a possibly substituted C ₁₋₆-alkyl residue with possibly at least one ether group as a chain member in the alkyl chain, a C₅₋₇-cycloalkyl residue, a possibly substituted benzyl residue or a C₃₋₆-alkenyl residue,
R³ stands for H, a C₁₋₆-alkyl or C₁₋₆-alkoxy residue,
R⁴ stands for H, a C₁₋₆-alkyl residue, a C₁₋₆-alkoxy residue, a C₁₋₆-alkylsulphonylamino residue, or for a possibly substituted C₁₋₆-alkanoylamino or benzoylamino residue,
13, compounds according to general formula XIII 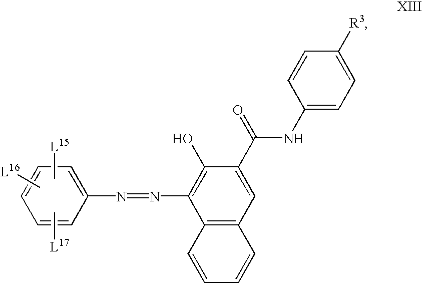
wherein
L¹⁵, L¹⁶ and L¹⁷, which are identical or different, stand for H, halogen, a nitro or cyano group, a C₁₋₆-alkyl residue, a C₁₋₆-alkoxy residue, a possibly substituted C₁₋₄-alkoxycarbonyl residue, a C₁₋₆-alkylsulphonyl residue, a possibly substituted phenylsulphonyl or phenylazo residue,
R³ stands for H, a C₁₋₆-alkyl or C₁₋₆-alkoxy residue,
and Palanil® Cyanin B and Dispersol® Tiefrot SF.

2. Nonwoven fabric as per claim 1, characterised in that, in general formula 1, A¹ and A², which are identical or different, stand for a phenyl residue possibly substituted with a C₁₋₈-alkoxy or —O—CH₂—C₃₋₇-cycloalkyl residue in ortho, meta or para position, wherein the alkyl chain of the alkoxy residue or the cycloalkyl ring possibly display at least one ether group as a chain member in the alkyl chain or the cycloalkyl ring, or for a residue with the formula —C₆H₄—OCH₂—COOC₂H₄OC₂H₅.

3. Nonwoven fabric as per claim 1 or 2, characterised in that, in general formula II,
L¹⁵, L¹⁶ and L¹⁷, which are identical or different, stand for H, Cl or Br, or for a nitro or cyano group,
R¹ and R², which are identical or different, stand for a methoxycarbonylethyl, 2-acetyloxyethyl, 2-cyanoethyl, ethyl or propyl residue, or for a residue with the formula —C₂H₄—O—CO—OCH₃ or —C₂H₄—O—CO—CH₂—O-phenyl,
R³ stands for H, a methoxy or ethoxy residue,
R⁴ stands for H, an acetylamino, ethanoylamino, benzoylamino or methylsulphonylamino residue.

4. Nonwoven fabric as per one of claims 1 to 3, characterised in that, in general formula III,
W¹ and W² stand for an ethyl residue,
X stands for an oxygen atom or an imino group,

5. Nonwoven fabric as per one of claims 1 to 4, characterised in that, in general formula IV,
A⁷ stands for a 3-methoxypropyl or 4,7-dioxaoctyl residue,
X stands for an oxygen atom.

6. Nonwoven fabric as per one of claims 1 to 5, characterised in that, in general formula V,
A¹ stands for H,
A⁴ stands for fluorine, chlorine, bromine, a 1-oxyhexan-6-ol, 2-methoxyphenyl, 3-methoxyphenyl, 4-methoxyphenyl, 2-ethoxyphenyl, 3-ethoxyphenyl, 4-ethoxyphenyl or phenoxy residue,
A⁵ and A⁶ each stand for H.

7. Nonwoven fabric as per one of claims 1 to 6, characterised in that, in general formula VI,
L¹⁵, L¹⁶ and L¹⁷, which are identical or different, stand for H, or for a nitro or cyano group,
R⁸ stands for a methyl residue,
R⁹ stands for a cyano group,
R¹⁰, R¹¹ and R¹², which are identical or different, stand for H, an unsubstituted phenyl, cyanoethyl, methoxycarbonylethyl or -3-oxa-5-hydroxypentyl-(C₂H₄—O—C₂H₄—OH) residue,
or residues R¹¹ and R¹², together with the nitrogen atom connecting them, stand for a pyrrolidinyl, piperidinyl, morpholinyl, thiomorpholinyl, thiomorpholinyl-S,S-dioxide, piperazinyl or N-(C₁₋₄-alkyl)piperazinyl residue, preferably for an N-methyl or N-ethylpiperazinyl residue.

8. Nonwoven fabric as per one of claims 1 to 7, characterised in that, in general formula VII,
L¹ stands for a nitro group,
L² stands for H,
L³ stands for H, a nitro group, or for a C₁₋₄-alkoxycarbonyl residue,
R¹ and R², which are identical or different, stand for a methoxycarbonylethyl, 2-acetyloxyethyl or 2-cyanoethyl residue,
R³ stands for H,
R⁴ stands for H or a C₁₋₃-alkyl residue.

9. Nonwoven fabric as per one of claims 1 to 8, characterised in that, in general formula VIII, L¹⁴ stands for an —SCN or nitro group,
R¹ and R², which are identical or different, stand for an acetyloxyethyl, cyanoethyl or methoxycarbonylethyl residue,
R³ stands for H, a C₁₋₆-alkyl or C₁₋₆-alkoxy residue,
R⁴ stands for H or a C₁₋₃-alkyl residue.

10. Nonwoven fabric as per one of claims 1 to 9, characterised in that, in general formula IX,
R¹ and R², which are identical or different, stand for H, an acetyloxyethyl or methoxycarbonyl residue,
R³ stands for a hydroxy residue,
R⁴ stands for H or a C₁₋₃-alkyl residue.

11. Nonwoven fabric as per one of claims 1 to 10, characterised in that, in general formula X,
R⁸ stands for a methyl residue,
R⁹ stands for a cyano group,
R¹³ stands for a C₁₋₃-alkyl residue,
R¹⁴ stands for an unsubstituted phenyl residue.

12. Nonwoven fabric as per one of claims 1 to 11, characterised in that, in general formula XI,
W¹ and W² each stand for an ethyl residue.

13. Nonwoven fabric as per one of claims 1 to 12, characterised in that, in general formula XII,
L⁷ stands for a nitro group,
L⁸ stands for H,
R¹ and R², which are identical or different, stand for a cyanoethyl, 2-phenylethyl, methoxycarbonyl ethyl or acetyloxyethyl, residue,
R³ stands for H,
R⁴ stands for a C₁₋₃-alkyl residue.

14. Nonwoven fabric as per one of claims 1 to 13, characterised in that, in general formula XIII,
L¹⁵, L¹⁶ and L¹⁷ stand for H,
R³ stands for a methoxy residue.

15. Nonwoven fabric as per claim 1, characterised in that it has been dyed and/or printed with at least one disperse dyestuff selected from the group comprising
1, the compound of general formula IV, wherein X stands for an oxygen atom and residue A⁷ for a 3-methoxypropyl residue,
2, the compound of general formula 11, wherein L¹⁵ stands for a nitro group in 2-position, L¹⁶ for a nitro group in 4-position, L¹⁷ for a Br residue in 6-position, R¹ and R² each for a 2-acetyloxyethyl residue, R³ for a methoxy residue and R⁴ for an acetylamino residue,
3, the compound of general formula 11, wherein L¹⁵ stands for a Cl residue in 2-position, L¹⁶ for a nitro group in 4-position, L¹⁷ for H in 6-position, R¹ and R² each for an acetyloxyethyl residue, R³ for H and R⁴ for an acetylamino residue,
4, the compound of general formula II, wherein L¹⁵ stands for a Cl residue in 2-position, L¹⁶ for a nitro group in 4-position, L¹⁷ for a Br residue in 6-position, R¹ and R² each for a methoxycarbonylethyl residue and R³ and R⁴ each for H,
and Palanil® Leuchtrot B and Dispersol® Rubin XF.

16. Nonwoven fabric as per one of claims 1 to 14, characterised in that it has been dyed and/or printed with a dyestuff mixture consisting of a red dyestuff, a yellow dyestuff and a blue dyestuff.

17. Nonwoven fabric as per claim 16, characterised in that it has been dyed and/or printed with a dyestuff mixture consisting of a yellow dyestuff of general formula II, a red dyestuff of general formula I and a blue dyestuff of general formula II.

18. Nonwoven fabric as per one of claims 1 to 17, characterised in that it consists of at least one polyester component and at least one polyamide component.

19. Nonwoven fabric as per claim 18, characterised in that the nonwoven fabric consists of 5 to 95% by weight polyester and 95 to 5% by weight polyamide, preferably 15 to 85% by weight polyester and 85 to 15% by weight polyamide, particularly preferably 30 to 70% by weight polyester and 70 to 30% by weight polyamide.

20. Nonwoven fabric as per one of claims 1 to 19, characterised in that the titre of the microfibres and/or microfilaments is ≦1 dtex.

21. Nonwoven fabric as per one of claims 1 to 20, characterised in that the polyamide is selected from the group comprising polyamide 6, polyamide 66 and polyamide 11.

22. Nonwoven fabric as per one of claims 1 to 21, characterised in that the polyester is selected from the group comprising polyethylene terephthalate, polypropylene terephthalate, polybutylene terephthalate, polylactic acid, their mixtures and copolyesters.

23. Nonwoven fabric as per one of claims 1 to 22, characterised in that it is a staple fibre nonwoven.

24. Nonwoven fabric as per one of claims 1 to 22, characterised in that it is a spunbonded nonwoven.

25. Nonwoven fabric as per one of claims 1 to 24, characterised in that it has a weight per unit area of 15 to 350 g/m², preferably 50 to 300 g/m², particularly preferably 80 to 200 g/m².

26. Method for manufacturing a dyed or printed nonwoven fabric as per one or more of claims 1 to 25, characterised in that the nonwoven fabric is treated with at least one disperse dyestuff selected from the group comprising compounds of general formulae I to XIII as per claim 1, Palanil® Cyanin B and Dispersol® Tiefrot SF.

27. Method as per claim 26, characterised in that dyeing is accomplished by the exhaust dyeing process.

28. Method as per claim 27, characterised in that the dyeing temperature is 60 to 145° C., preferably 80 to 140° C., particularly preferably 120 to 135° C.

29. Method as per claim 27 or 28, characterised in that the dyeing time is 5 to 120 minutes, preferably 20 to 60 minutes, particularly preferably 25 to 45 minutes.

30. Method as per one of claims 27 to 29, characterised in that the pH value during dyeing is between 2 and 11, preferably lies in the acid to neutral range, and is particularly preferably 4 to 6.

31. Method as per claim 26, characterised in that dyeing is accomplished by the thermosol dyeing process.

32. Method as per claim 31, characterised in that the fixing temperature is 80 to 240° C., preferably 100 to 220° C., particularly preferably 150 to 210° C.

33. Method as per claim 31 or 32, characterised in that the fixing time is between 1 second and 30 minutes, preferably 15 seconds to 10 minutes, particularly preferably 45 seconds to 5 minutes.

34. Method as per claim 26, characterised in that printing is accomplished by a direct printing process, preferably the rotary, screen or inkjet printing process.

35. Method as per claim 26, characterised in that printing is accomplished by a transfer printing process.

36. Method as per one of claims 26 to 35, characterised in that dyeing or printing of the nonwoven fabric is followed by scouring, preferably alkaline or acidic, reductive scouring, particularly preferably alkaline, reductive scouring at elevated temperature.

37. Method as per one of claims 26 to 36, characterised in that aftertreatment with a dye fastness-improving agent is performed after dyeing or printing, after reductive scouring, during or after finishing, or after making up.

38. Method as per claim 37, characterised in that the dye fastness-improving agent is selected from the group comprising possibly substituted arylsulphonic acids, hydroxyarylsulphonic acids, arylsulphonates, hydroxyarylsulphonates, alkylarylsulphonates, polycondensed functional amines, monomeric or polymeric quaternary ammonium compounds and possibly their corresponding condensation products.

39. Method as per claim 37 or 38, characterised in that the dye fastness-improving agent is added to the rinsing bath in a quantity of 0.1 to 15% by weight, preferably 2 to 5% by weight, referred to the nonwoven fabric used.

40. Method as per claim 39, characterised in that the rinsing bath has a temperature of 20° C. to 150° C., preferably 40° C. to 70° C.

41. Method as per claim 39 or 40, characterised in that the rinsing process in the rinsing bath lasts 1 to 150 minutes, preferably 20 to 100 minutes.

42. Method as per one of claims 26 to 41, characterised in that additional dyeing or printing is performed with at least one dyestuff selected from the group comprising vat dyestuffs, leuco vat dyestuffs, sulfur dyestuffs and water-soluble sulfur dyestuffs.
